(19) United States
(12) Patent Application Publication
(10) Pub. No.: US 2004/0171375 A1
(43) Pub. Date: Sep. 2, 2004

(54) Method for launching an application using a mobile station

(76) Inventor: Raymond Chow-Toun, Geneva (CH)

Correspondence Address: PEARNE & GORDON LLP, 1801 EAST 9TH STREET, SUITE 1200, CLEVELAND, OH, 44114-3108, US

(21) Appl. No.: 10/760,776

(22) Filed: Jan. 20, 2004

Related U.S. Application Data
(63) Continuation of application No. PCT/CH02/00129, filed on Mar. 1, 2002.

(30) Foreign Application Priority Data
Jul. 25, 2001 (CH) CH1384/01
Aug. 10, 2001 (CH) CH1484/01

(51) Int. Cl. H04M 3/00

(52) U.S. Cl. 455/418; 455/412.1

(57) ABSTRACT

Method for starting an application with the help of a mobile equipment (26), characterized by the following steps:

a sequence comprising only numbers and/or “*” or “#” characters is introduced into said mobile equipment placed in the idle mode,

the introduction of the sequence is confirmed by pressing on the key for establishing a connection,

a program in said mobile equipment and/or in an identification card in said mobile equipment launches said application when said sequence has a predefined particular syntax.

### REFERENCE DATA

This application is a continuation based on PCT/CH02/00129, filed on Mar. 1, 2002.

### FIELD OF THE INVENTION

The present invention concerns a device and a method for starting applications from a mobile station, for example from a portable phone or from an electronic agenda (PDA) equipped with a communication interface and allowing to establish a communication.

2. Description of Related Art

The current portable phones and the advanced electronic agendas often allow to run different applications offering various functionalities. These applications are constituted by data-processing programs or applets generally loaded into the mobile equipment. The mobile subscriber can generally access them through a menu system or by selecting an icon in a graphical user interface. Due to the limited size of the screens and to the restricted number of keys on a mobile equipment, notably on a mobile phone, these solutions are however not very ergonomic such that a lot of users give up using them. Furthermore, it is difficult to introduce new applications without modifying the hierarchy of the foreseen menus, which tends to destabilize the users. Furthermore, the graphical interface systems are costly in terms of used memory space and compute time for the processor of the mobile phone.

The international application WO98/27760 describes for example a mobile apparatus comprising a currency conversion application. The application carrying out the conversion is only accessible through menus and sub-menus which are tedious and not very ergonomic for the mobile subscriber.

Different solutions were proposed to equip the mobile phones with additional keys in order to start specific applications. The arrangement and the functions assigned to these keys are badly standardized, such that their handling must be learned. One also knows mobile equipments allowing to start applications with the help of vocal commands, whose interpretation is costly in terms of required compute power.

### BRIEF SUMMARY OF THE INVENTION

An aim of the invention is to propose a new method to start applications from a mobile station which avoids the drawbacks of prior art processes.

According to the invention, these aims are achieved by a method comprising the elements of claim 1, preferred embodiments being furthermore indicated in the dependent claims.

In particular, these aims are achieved by a method comprising the following steps:

a sequence is introduced into said mobile equipment placed in the idle mode,

the introduction of the sequence is confirmed by pressing the key for establishing a connection,

a command interpreter program in said mobile equipment and/or in a peripheral connected to said mobile equipment, for example in a subscriber identification card inserted in said mobile equipment launches said application when said sequence has a predefined particular syntax.

In a preferred embodiment, said sequence comprises only numbers and/or “*” or “#” characters and can thus be introduced directly from the keyboard of the mobile equipment. Other characters can be foreseen when the keyboard or the input means of said mobile equipment allow it.

In a preferred embodiment said predefined particular syntax is a syntax different from that used to establish a phone communication. The command interpreter program in the mobile equipment or preferably in the subscriber identification module (SIM card) is thus able to analyze the numerical sequences composed by the mobile subscriber and to check if these data correspond to a communication establishing or USSD sending request, in which case the interpreter program abandons its intervention and lets the call or the sending of USSD perform normally. In the opposite, if the syntax of the sequence corresponds to a predefined pattern, the command interpreter program launches an application run by the SIM card, by the mobile equipment and/or by a remote server.

The invention thus notably consisted in extending the functionality of the line for introducing phone numbers so that it becomes a line for entering commands into an operating system with a command line interface. Such interfaces are often designated by the acronym CLI (command line interface).

The invention also consisted in defining a syntax for commands introduced on this command line, said syntax comprising only key sequences that can be distinguished from the sequences of digits entered for requesting the establishing of a phone communication or the sending of a USSD. The input of a command is preferably validated by the key for requesting communication establishing (CALL or OK key on most portable apparatuses).

The system of the invention can involve a remote server or set of servers accessible through the mobile telecommunication network. The server provides, among others, the following functionalities:

Installation and maintenance of the command interpreter program and of the applications in the mobile equipment and/or in the SIM card. These interventions can be done with the help of messages sent via the aerial interface (OTA technology, Over-The-Air) to the mobile equipment or during the personalization of the SIM card of the mobile apparatus or directly during the manufacturing of the mobile equipment or of any peripheral equipment connectable to the mobile equipment.

Identification of the mobile subscriber and recording of the course of his requests, for example in order to establish a profile of the mobile subscribers. The mobile subscriber is preferably identified thanks to identification data read or generated in the SIM card or in another peripheral equipment connected to the mobile equipment and transmitted in the requests sent to the server. The identification data include for example an IMSI calling number (International Mobile Subscriber Identification) and/or an electronic signature generated by the SIM card.

Management of the mobile subscriber's profile and preferences (preferred communication language, conversion parameters, geographical location, personalized criteria depending on the selected application) defined via various interfaces (mobile apparatus of the mobile subscriber, WEB site, e-mail, speech or DTMF impulse codes recognition system).

Preparing and sending of a possible reply towards the mobile equipment of the mobile subscriber, for example with the help of messages of the SMS or other types.

The claimed command introduction method offers the advantage of being intuitive and of not requiring tedious learning. The mobile subscriber doesn't have to leave his classical phone call environment nor to carry out a selection in a menu for example. The handling is thus simplified, allowing for a maximal running speed. The operation is compatible with the major part of the mobile telecommunication devices' installed-base (GSM, UMTS, GPRS etc) and doesn't require any advanced equipment.

### BRIEF DESCRIPTION OF THE DRAWINGS

The present invention will be better understood by reading the description given as an example and illustrated by the figures showing:

FIG. 1 an overall view of the system including an identification card in a mobile equipment and a remote server.

FIG. 2 a flow diagram of the steps of the method of the invention run by the identification card.

FIG. 3 shows the input screen of a command for launching a currency conversion application.

FIG. 4 shows the screen of the mobile equipment during the display of the result generated by the remote server following the introduction of the above command.

### DETAILED DESCRIPTION OF THE INVENTION

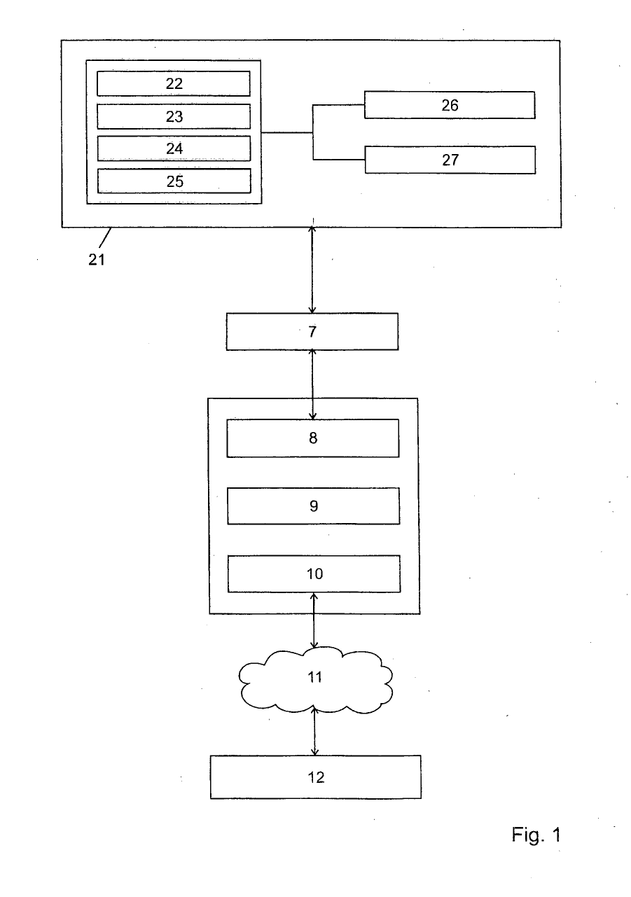

FIG. 1 shows a system according to the invention comprising a mobile station 21, for example a GSM, GPRS, HSCSD or UMTS mobile phone or an electronic agenda (PDA) equipped with a telecommunication interface. The mobile station 21 is able to communicate with a remote server 8-9-10 through a message center 7, for example a SMSC short message server (Short Message System Center) managed by the mobile network operator of the network of the user. The remote server 8-9-10 can in turn be connected via a network 11, for example Internet, to the server 12 of an added value service provider.

The mobile station 21 comprises a mobile equipment 26 and a subscriber identification module 27, for example a removable SIM smart card (Subscriber Identification Module) or a virtual card. Various modules 22 to 25 are stored either in the SIM card, or in the mobile equipment 26 of the mobile station 21. The mobile equipment can comprise or be directly connected to various peripherals, for example a smart battery, a smart card, a removable module inserted in a slot, for example a PC-Card reader, or a connector of the mobile equipment, etc. In the interest of simplification, the term mobile equipment will thus indicate in the rest of the description and of the claims the equipment itself, for example the mobile phone or the PDA, as well as the peripheral or peripherals connected to this mobile equipment.

The module 22 is a command interpreter program able to intercept the sequences introduced by the mobile subscriber on the keyboard of the mobile equipment 26 in the idle mode, i.e. in the same mode as for entering a number before establishing a phone call, and to check the syntax of these sequences. When this syntax corresponds to a predefined format, different from the format used to establish a telephone communication or to send a USSD message, the command interpreter program 22 launches an application 25 corresponding to this sequence. In a preferred embodiment, in a GSM network, the command interpreter program 22 is realized in the SIM card with the help of a call control mechanism (“CALL CONTROL”) being part of the “SIM application toolkit” functionalities from the GSM11.14 norm on. This mechanism allows to intercept the sequences introduced by the mobile subscriber from the idle mode of the mobile equipment which normally allows him to dial a phone number. The call control mechanism thus allows to send these sequences to a call control routine in the SIM card which carries out the syntax check and the launch of applications. However, it would also be possible within the frame of this invention to use a command interpreter program 22 in the mobile equipment 26, including in its peripherals, for example a program which intercepts and analyzes the key sequences introduced by the mobile subscriber even before transmitting them to the SIM card.

The module 23 contains the preferences and information of the mobile subscriber which can be used by the command interpreter program 22 and/or by specific applications 25. The preferences of the mobile subscriber can for example include his rights to run specific types of applications; in this case, the module 22 launches an application corresponding to a predefined syntax only if the module 23 indicates that the mobile subscriber is authorized to run this application. The preferences of the mobile subscriber can also include parameters used by several applications, for example the mobile subscriber's language, his name, his address, his billing address, his e-mail address, or parameters specific to each use. It is also possible to include dynamically varying parameters in these preferences, for example the mobile subscriber's instant location or the balance of a monetary account stored in the card and debited when some applications are being used. These preferences and information can be stored in the SIM card 27 and/or in the mobile equipment 26. It is also possible within the frame of this invention to retrieve mobile subscriber's preferences and information from a remote server accessible for example via the mobile communication network.

The module 24 allows to control the display of the mobile equipment 26 according to the results of the command interpreter program 22 and/or of the applications 25. The module 24 allows for example to display a wait message during the running of the command interpreter program 22, to request possible additional parameters demanded by the applications 25 and to display the results provided by these applications. Again, the module 24 can comprise programs stored in the SIM card 27 and/or in the mobile equipment 26.

The module 25 comprises one or more applications launched by the command interpreter program 22 when a command line with a particular syntax was recognized. The started particular application and the parameters transmitted to this application depend on the command line introduced by the mobile subscriber. The applications can be placed in the SIM card, for example in a rewritable memory area (EEPROM) of the SIM card. It is also possible to place at least some applications in the mobile equipment 26. The applications can moreover send requests to the remote server 8-9-10 in order to have it run procedures or in order to get values. These requests are preferably electronically secured, for example encrypted and signed with the help of an individual signature key stored in the SIM card, in order to guarantee their confidentiality, their authenticity, their non-repudiation and the authenticity of the sender. An example of application 25 relates to data conversion, for example of monetary data, which can be carried out with the help of an application in the SIM card and/or in the mobile equipment, possibly by getting the conversion rate or having the whole conversion processing carried out from the remote server 8-9-10 and/or from a peripheral near the mobile equipment 26. It is also possible to have the remote server 8-9-10 carrying out the conversion. Other examples of applications will be described below. It is in fact possible to trigger any local or remote application by using the described “CALL CONTROL” mechanism.

The system of the invention comprises moreover a message center 7 in order to receive and transfer the request messages possibly sent by the applications 25. The message center is accessible via the mobile telecommunication network in which the mobile station 21 is connected and can be managed for example by the operator of this mobile network. In the case where these requests are constituted by SMS, the message center can be constituted by a SMSC (Short Message System Center). In the case where these requests are transmitted by email, the center 7 will be constituted by an electronic message server. Other types of message centers can be foreseen according to the type of carrier used for the requests sent by the applications 25. The requests can for example also be sent in the form of data packets via a packet transmission network.

The server 8-9-10 comprises a module 8 allowing to run the requests sent through the mobile telecommunication network and to run the requested applications. The module 8 can be connected to the message center 7 via any type of link, for example via a TCP-IP link through a virtual private network VPN. The run request can use dynamic parameters 9 which can be modified at any time and stored in the module 8 or accessible from this server, for example through an http or FTP link. These parameters can include preferences of the mobile subscriber, for example his preferred communication language, his address, preferences proper to each program, etc., as well as a mobile subscriber profile established from a number of successive requests from the same automatically identified mobile subscriber.

One or more interfaces 10 can be foreseen in the server 8-9-10 in order to allow the mobile subscriber to modify the parameters 9. The modifications can for example be introduced from the mobile station 21, from a computer connected to the Internet or from another phone or data terminal with the help of SMS, of email, of vocal or DTMF commands analyzed with the help of a speech recognition module, or through a WEB page for example.

The system of the invention can moreover comprise one or more other servers 12 managed by added value service providers and to which the server 8-9-10 can connect through a network 11, for example Internet.

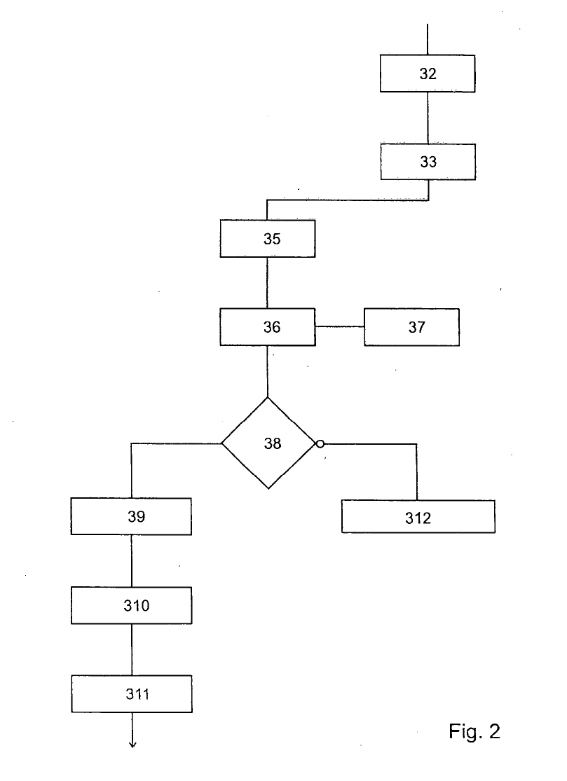

We now will describe—using FIG. 2—the steps of the command interpreter program 22 of the invention. During step 32, the mobile station 21 is in idle mode. In this mode, the mobile station waits for the mobile subscriber to introduce a sequence of digits in order to establish a communication. The mobile station thus isn't within a particular menu of the user interface.

A sequence of digits and/or of characters * or # is introduced by the mobile user during step 33 and ended by the CALL key usually used to establish a communication. If the keyboard of the mobile equipment 26, for example in the case of a PDA, comprises alphanumeric keys and/or additional special characters, the introduced sequence can include alphanumeric characters and/or additional special characters.

According to the invention, routines 35 to 311 of the program 22 allow to distinguish between a sequence for establishing a communication and a command for launching an application. In case of a command for launching an application, the routines 35 to 311 also allow to start this application directly.

The control procedure 35 intercepts the sequence introduced by the mobile subscriber during the procedure 33. The procedure 35 can for example use the mechanism of <<Call Control>> to intercept the sequence introduced by the mobile subscriber from the idle mode of the mobile station 21. During step 36, the syntax of this sequence is analyzed using algorithms 37 to check whether the syntax of the introduced sequence belongs to a predefined class of command syntaxes or in the opposite to the class of syntax of the USSD or of the subscriber phone numbers or of other special services. The predefined class of command syntaxes can include for example all sequences of character strings including * or # characters and which nevertheless are distinct from USSD characters. Various different distinct classes of syntaxes can be foreseen to start different applications.

After the analysis 36, the test of the sequence introduced by the mobile subscriber is declared, during test 38, either:

Negative. In this case, the analysis of the sequence is interrupted the mobile equipment can continue normally the call requested by the subscriber to the introduced number (step 312).

Positive. In this case, the procedure continues to the next instruction 39.

During procedure 39, the mobile equipment 26 is placed in wait mode (“More Time” command requested to the mobile equipment) to suspend any other activity of the mobile equipment 26 while waiting for the next instruction 311.

According to the sequence introduced by the mobile subscriber during procedure 33, additional parameters can be required from him or looked for in the SIM card 27 and/or in the mobile equipment 26 and/or in a remote server, during step 310. These additional parameters depend on the selected specific application. In the case of a conversion request, the required parameters comprise for example preferences stored beforehand by the mobile subscriber or information relative to his geographical location. According to the application, at least some parameters can be directly included in the initial sequence introduced by the mobile subscriber on the command line.

During procedure 311, the application requested by the mobile subscriber will finally be run. This step can involve the running of a program or of an applet in the SIM card 27 and/or in the mobile equipment 26, and/or the sending of a request message to the remote server 8-9-10, for example the automatic sending of a SMS or of an email to the server in charge of running the request bringing the application into play. After the running of this application, during which the module 24 will if necessary have displayed results on the screen of the mobile equipment or indicated to the mobile subscriber to provide possible additional parameters, the mobile station 21 returns to step 32 in its “idle mode” call waiting mode.

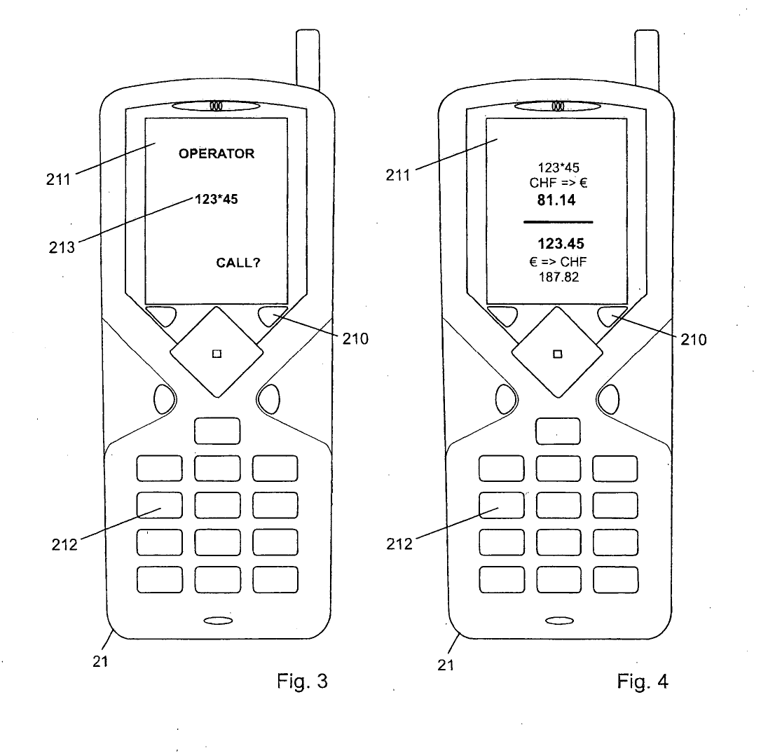

FIG. 3 illustrates the introduction of a sequence corresponding to a command to launch a currency conversion application. The mobile station is here in an idle mode. In this mode, the mobile subscriber can perform a call by introducing the number of the desired called party with the help of the keyboard 212 and by confirming with the help of the CALL key 210. However, on FIG. 3, instead of introducing a sequence corresponding to a call number, the mobile subscriber introduces a sequence 213, in this example 123*45, corresponding to a command for launching a conversion application to convert the amount 123,45 itself based on a predefined couple of currencies corresponding to the last information of the mobile subscriber's profile or according to an option related to his geographical location. The command 213 for currency conversion is introduced in the same way as a phone number sequence. The syntax of the introduced command 213 is however different from that of a phone number, since in this example the introduced series distinguishes itself from the class of the subscribers' phone number syntaxes and from that of the USSD. The command interpreter program 22 which is launched following the selection of the CALL key is able to recognize this particular sequence and to launch the running of a converter application instead of attempting to establish a phone call which wouldn't succeed with such a syntax. The application preferably uses mobile subscriber's preferences 23 stored in the SIM card, in the mobile equipment or in a remote server 8-9-10 to determine the language in which the results must be displayed, the pair of currencies in which the amount will be converted in the both directions. The conversion itself can be carried out by the SIM card or by the mobile equipment with the help of conversion rate within the SIM card, within the mobile equipment or obtained from the remote server 8-9-10 with the help of an automatically sent request for conversion rates demand. It is also possible to have the conversion calculation being run by the remote server 8-9-10.

FIG. 4 shows the result displayed by the converter application 25. In this example, the converter application converts the amount 123,45 introduced by the mobile subscriber by providing the result in both possible conversion directions according to the information of the mobile subscriber's profile or to his geographical location during the request. In this example, the application carries out and displays on the same screen the conversion of 123,45CHF into equivalent Euro and of 123,45 Euro into equivalent CHF (Swiss francs). The mobile subscriber's conversion request thus only contains the amount to be converted without needing to specify the direction of the conversion.

The one skilled in the art will understand that the interception method of the Call Control mechanism allows to launch any application run by the SIM card, by the mobile equipment or by a remote equipment and that the invention is thus not limited to the problem of currency conversion. Non monetary conversions, for example measurement unit conversions, can for example be carried out the same way. It is also possible to launch games, in particular Lottery games, betting games, games of skill or arcade games, the same way. One could also, within the frame of this invention, automatically send requests for ordering products or information to remote providers 12. The mobile subscriber's request to the providers 12 can also be used to activate remote automats. It is also possible to automatically connect the subscribers dialing an obviously wrong number to a call or phone directory center.

1. A method for starting an application with the help of a mobile equipment, comprising the following steps:
a command interpreter program is installed in said mobile equipment and/or in a subscriber identification card in said mobile equipment with the help of messages sent via an aerial interface (OTA technology, Over-The-Air)
said application is placed in a rewritable memory area,
a sequence is introduced into said mobile equipment placed in the idle mode,
said program launches said application when said sequence has a predefined particular syntax.

2. The method of claim 1, the introduction of the sequence being confirmed by pressing the key for establishing a connection.

3. The method of claim 2, said sequence only comprising numbers and/or “*” or “#” characters.

4. The method of claim 1, said predefined particular syntax being a syntax different from that used to establish a phone communication or to send an USSD message.

5. The method of claim 4, said application being an operand conversion application, the result of the application being displayed on the display of said mobile equipment.

6. The method of claim 5, the format of said operand comprising a first numerical part, a separator consisting of an alphanumeric character present on the numerical keyboard of said mobile equipment, and a second numerical part with a fixed or limited number of digits.

7. The method of claims 5, said application launching the conversion of said operand in two distinct conversion directions, both results being simultaneously displayed on said display.

8. The method of claim 1, said application involving a communication with a remote server.

9. The method of claim 8, said application sending a request to said remote server.

10. The method of claim 9, said request being sent to said server with the help of an SMS short message.

11. The method of claim 9, said request being sent to said server in the form of data packets in a packet transmission network.

12. The method of claim 9, said request being sent to said server with the help of an e-mail.

13. The method of claim 9, said server sending a message including a response to said request, said response being displayed on said display.

14. The method of claim 13, said response depending on the profile of the mobile subscriber.

15. The method of claim 14, at least some elements of said profile being stored in said remote server.

16. The method of claim 14, at least some elements of said profile being stored in the identification card.

17. The method of claim 1, said application being run by a subscriber identification card in said mobile station.

18. The method of claim 1, said application being run by said mobile equipment.

19. The method of claim 1, said program being a command interpreter program run by a subscriber identification card in said mobile station.

20. The method of claim 19, said subscriber identification card being a SIM card provided with SIM Toolkit functions, said command interpreter program using call control functions to check the syntax of said sequences.

21. The method of claim 20, said command interpreter program and/or said application being loaded into the subscriber identification card during personalization by the mobile operator.

22. The method of claim 20, said command interpreter program and/or said application being downloaded into the subscriber identification card over the air.

23. The method of claim 1, said command interpreter program being run by said mobile equipment.

24. The method of claim 1, several distinct applications being launched by introducing different sequences recognized by said command interpreter program.

25. Identification card for mobile equipment, comprising a command interpreter program installed with the help of messages sent via the aerial interface of a mobile equipment (OTA technology, Over-The-Air) to intercept sequences introduced into a mobile equipment in the same way as sequences for establishing a phone call, to recognize that the format of these sequences is different from the format of a phone number and different from the format of an USSD message, and to start in this case an application placed in a rewritable memory area.

26. Mobile equipment comprising a command interpreter program installed with the help of messages sent via the aerial interface of said mobile equipment (OTA technology, Over-The-Air) to intercept sequences introduced into said mobile equipment in the same way as the sequences for establishing a phone call, to recognize that the format of these sequences is different from the format of a phone number and different from the format of an USSD message, and to start in this case an application placed in a rewritable memory area.
